(19) United States
(12) Patent Application Publication
(10) Pub. No.: US 2005/0274095 A1
(43) Pub. Date: Dec. 15, 2005

(54) Filter for purifying air and keeping cleanly the ducts of a hot air system or central air exchanger

(76) Inventor: Jean-Pierre Blais, Quebec (CA)

Correspondence Address: Mr. Jean-Pierre Blais, 1028 Carre Beausoleil, St. Jean Chrysostome, QC, G6Z 1P9, CA

(21) Appl. No.: 10/867,319

(22) Filed: Jun. 15, 2004

(51) Int. Cl. B01D 46/00

(52) U.S. Cl. 55/490

(57) ABSTRACT

A filter for purifying air and keeping cleanly the ducts of a hot air system or central air exchanger, and which automatically takes the shape of the inlet from a duct when it is installed.

### BACKGROUND OF THE INVENTION

1. Field of the Invention

The present invention relates to a device for purifying air and keeping cleanly the ducts of a hot air system or central air exchanger, and more particularly to a filter that automatically takes the shape of the inlet from a duct when it is installed.

2. Description of the Related Art

A search of prior art records has unveiled the following U.S. patents:
1. U.S. Pat. No. 4,804,392 issued in 1989 to Spengler;
2. U.S. Pat. No. 4,552,657 issued in 1985 to Ogawa; and
3. U.S. Pat. No. 4,666,531 issued in 1987 to Minard.

The patents to Spengler, Ogawa and Minard are probably the most relevant.

It is known to use different conical filters in order to purify air and keep cleanly the ducts of a hot air system or central air exchanger.

At present, one disadvantage of using conical filters is that none of them automatically takes the shape of the inlet from a duct when it is installed.

The gist of the invention is therefore to provide a filter that automatically takes the shape of the inlet from a duct for hot air system or central air exchanger when it is installed.

### SUMMARY OF THE INVENTION

In its simplest form, the use of the filter of this invention is that it automatically takes the shape of the inlet from a duct when it is installed.

### BRIEF DESCRIPTION OF THE DRAWINGS

FIGS. 1a, 1b and 1c show a perspective view of a filter which automatically takes the shape of the inlet from a duct when it is installed.

### DETAILED DESCRIPTION OF THE INVENTION

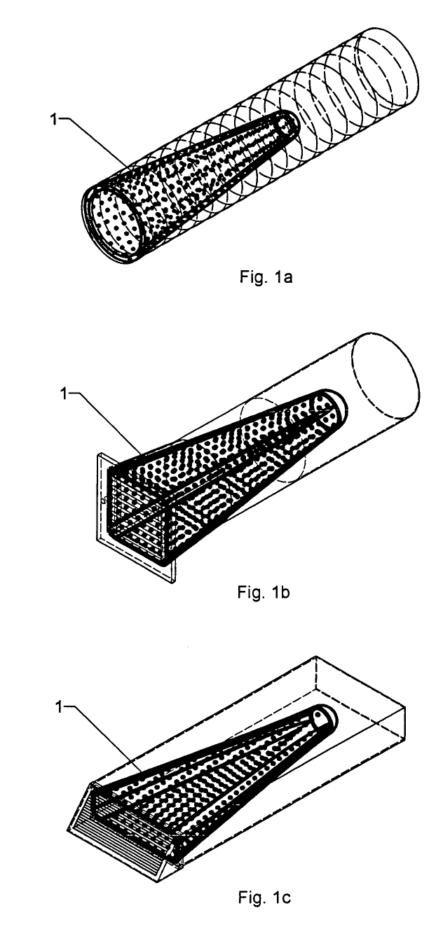

Referring to the FIGS. 1a, 1b and 1c, it may be seen that the filter (1) of the present invention is used for purifying air and keeping cleanly the ducts of a hot air system or central air exchanger, and which automatically takes the shape of the inlet from a duct when it is installed.

1. A filter for purifying air and keeping cleanly the ducts of a hot air system or central air exchanger, and which automatically takes the shape of the inlet from a duct when it is installed.
